(19) United States
(12) Patent Application Publication
(10) Pub. No.: US 2004/0246346 A1
(43) Pub. Date: Dec. 9, 2004

(54) Photographing apparatus for automatically setting compression format and method thereof

(76) Inventors: Yong-ho Kim, Seoul (KR); Yong-hyun Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/855,720

(22) Filed: May 28, 2004

(30) Foreign Application Priority Data
Jun. 3, 2003 (KR) 2003-35771

(51) Int. Cl. H04N 9/00

(52) U.S. Cl. 348/222.1

(57) ABSTRACT

A photographing apparatus capable of automatically setting the compression ratio and a method thereof. The photographing apparatus has a digital video camera (DVC) unit, a DVC signal processing block to output digital motion picture data, first and second compression units to compress the digital motion picture data into a first and second format data. The apparatus also has a first and second recording media to store the first and second compressed data, a recording medium selecting switch unit to select one of the first or the second recording media, and a control unit to control the transmission of the digital motion picture data one of the first or the second compression units. As a result, the storage space of the recording medium can be used more efficiently, and the user is not inconvenienced by having to set the appropriate compression method every time he or she selects a camera or a recording medium.

This application claims the benefit under 35 U.S.C. § 119(a) of Korean Patent Application No. 2003-35771 filed Jun. 3, 2003, in the Korean Intellectual Property Office, the disclosure of which is incorporated herein by reference in its entirety.

### BACKGROUND OF THE INVENTION

1. Field of the Invention

The present invention relates to a photographing apparatus and a method thereof. More particularly, the present invention relates to a photographing apparatus having a plurality of different cameras and different recording media, which is capable of automatically selecting a compression format for image data in accordance with the type of a camera and a recording medium selected by a user, and a method thereof.

2. Description of the Related Art

Generally, a digital still camera (DSC) converts an image received through a lens into a digital signal, and stores the digital signal on a recording media such as a hard disk or a memory card. More specifically, instead of recording the image on film, the DSC can store the image on the recording media and transfer the digital image directly to the computer without using other devices such as a scanner. Since DSC's are highly compatible with personal computers (PC), the DSC enables easy editing or correction. In addition, the DSC is connectible to an external computer to transmit the captured images. Further, the DSC is similar in structure to general cameras, so the DSC is convenient to carry. The DSC mainly includes a lens device, a memory device, a signal converter and a display. However, due to limitations in the memory capacity of recording media, the DSC is usually only used for capturing still images. Although the DSC is capable of capturing motion pictures, motion pictures require extensive storage, and, therefore, only a very limited-duration motion picture can be stored on current memory devices. Therefore, the DSC is not effective for capturing motion pictures. Besides, since many DSC's do not have any device to record and reproduce sound, it is somewhat ineffective to use the DSC for motion picture recording and reproducing. In order to compensate for these shortcomings of the DSC, it was suggested that the DSC be equipped with an image and sound recording and reproducing apparatus. For example, a camcorder records and reproduces images and sounds of an object on a recording media such as a tape. A digital video camera (DVC) is also an example of the same.

The DVC mainly includes a lens device, a signal converter, a deck device to record and reproduce captured images, and a display. The DVC usually uses a cassette tape as a recording medium, and therefore, the cassette tape is usually mounted on the deck device to record the motion pictures as they are captured. Additionally, the DVC is provided with microphone and speaker devices, and is capable of photographing with the cassette tape for more than 1 hour. The DVC can also photograph still images. However, because it has lower resolution and image quality when compared to the DSC, the DVC is used mainly for capturing motion pictures. Further, because the DVC has more complex functions and construction than a DSC, the DVC is usually larger in size and more expensive than the DSC.

Accordingly, in order to photograph motion pictures as well as still images, a customer usually purchases both a DSC and DVC. As a result, the customer has a budget problem because they have to buy two expensive devices. Furthermore, the customer has to carry both a DSC and a DVC to use them.

In an effort to resolve the problem as mentioned above, an integrated DSC/DVC, or digital camera/camcorder (so-called ‘DUOCAM’) in which a DSC and a DVC are integrated into a single casing, has been developed.

The DUOCAM uses both the memory card and the magnetic tape as a recording media for storing images or motion pictures) and accordingly, the user may select either of the two to record the images he or she is photographing. The memory card has an advantage in that it is compact-sized and can directly connect to the PC either through a reader or via a cable connection to the DUOCAM, which enables easy transmission of data. However, the memory card has a relatively small memory capacity. The magnetic tape has a large memory capacity, but cannot compare to the memory card when it comes to compactness and data transmission efficiency. Meanwhile, in order to use the memory space of the respective recording medium efficiently, the DUOCAM compresses the image data before storing the same. There are various compression formats for the image data, but generally, data size decreases with higher compression but the image quality also deteriorates. Conversely, image quality is typically better with a lower compression ratio, but the data size is increased.

Although viewers prefer good image quality, limitations in storage capacity of the recording medium is the problem. Accordingly, it is necessary to consider the image quality and the storage capacity of the recording medium, when automatically setting the compression format according to the recording medium.

Furthermore, because the DUOCAM photographs different types of images using different cameras, there are different compression formats for each type of the image. Accordingly, it is also necessary to automatically set an appropriate compression format for the image to be stored.

Otherwise, the user has to set the compression format for the camera and the recording medium that he/she selected, which could be quite cumbersome.

### BRIEF DESCRIPTION OF THE DRAWINGS

The above aspects and features of the present invention will be more apparent by describing certain embodiments of the present invention with reference to the accompanying drawings, in which:

FIG. 1 is a perspective view of a photographing apparatus constructed according to an embodiment of the present invention;

FIG. 2 is a block diagram showing a photographing apparatus constructed according to an embodiment of the present invention;

FIGS. 3A to 3E are views for the explanation of a complex camera unit constructed according to an embodiment of the present invention;

FIG. 4 is a view for the explanation of a recording medium according to an embodiment of the present invention;

FIGS. 5A and 5B are views for the explanation of a recording medium setting unit according to an embodiment of the present invention;

FIGS. 6 to 10 are views for the explanation of a mode selection switch unit constructed according to an embodiment of the present invention; and

FIG. 11 is a flowchart for the explanation of the photographing method according to an embodiment of the present invention.

Throughout the drawings, it should be understood that like reference numbers refer to like features and structures.

### SUMMARY OF THE INVENTION

The above disadvantages are overcome and other advantages realized by embodiments of the present invention. Embodiments of the present invention comprise a digital video camera unit with a signal processing unit to output digital motion picture data. A first compression unit compresses the digital motion picture data into first compressed data using a first compression format. A second compression unit compresses the digital motion picture data into second compressed data using a second compression format, which is different from the compression format of the first compression unit. Different recording media are used to store the first and second compressed data. The recording medium for storing the compressed data is selected by a recording medium selecting switch. Finally, a control unit controls the transmission of the digital motion picture data to one of the first or the second compression units based on the recording media selected by the recording medium selecting switch.

### DETAILED DESCRIPTION OF THE PREFERRED EMBODIMENTS

Certain embodiments of the present invention will now be described in greater detail with reference to the accompanying drawings.

The matters defined in the following description such as a detailed construction and elements are provided to assist in a comprehensive understanding of the invention, and are not meant to be limiting. Thus, it is apparent that the present invention can be carried out without those defined matters. Also, well-known functions or constructions are not described in detail since they would obscure the invention in unnecessary detail.

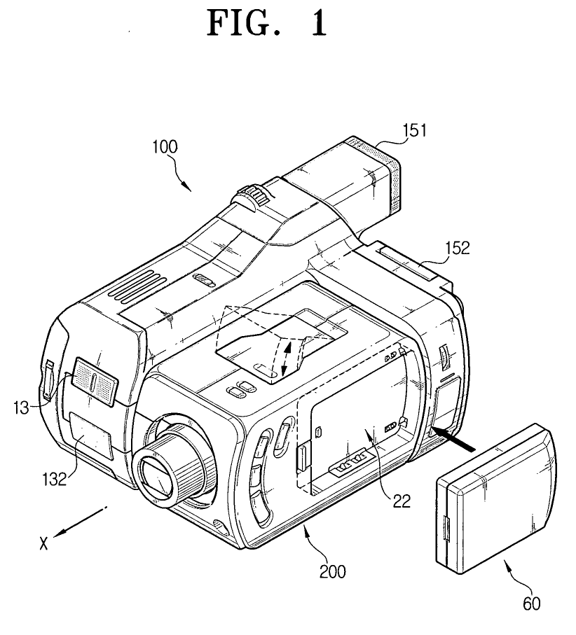

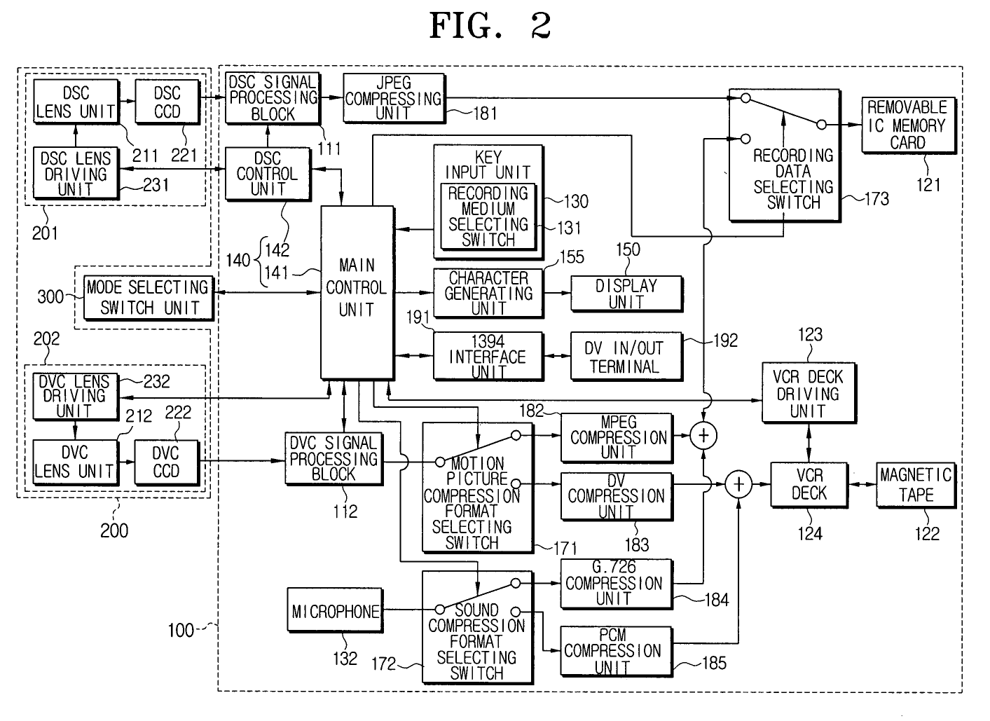

FIG. 1 is a perspective view of a photographing apparatus according to an embodiment of the present invention, and FIG. 2 is a block diagram of the photographing apparatus. Referring to FIGS. 1 and 2, the photographing apparatus includes a main body 100, a complex camera unit 200 connected to the main body 100 and a mode selection switch unit 300.

Referring to FIG. 2, the complex camera unit 200 includes a digital still camera (DSC) unit 201, and a digital video camera (DVC) unit 202. The DSC unit 201 and the DVC unit 202 are for different image types, and therefore, they are driven independently from each other. The DSC unit 201 includes a DSC lens unit 211, a DSC CCD 221 and a DSC lens driving unit 231, and the DVC unit 202 includes a DVC lens unit 212, a DVC CCD 222 and a DVC lens driving unit 232.

The DSC lens driving unit 231 drives the DSC lens unit 211 according to the control of the DSC control unit 142. An optical image, which is converged through the DSC lens unit 211, is photoelectrically converted into electric signals at the DSC CCD 221, and the converted signals are transmitted to the DSC signal processing block 111. The DSC CCD 221 preferably uses progressive scanning.

The DVC lens driving unit 232 drives the DVC lens unit 212 according to the control of the main control unit 141. An optical image, which is converted through the DVC lens unit 212, is photoelectrically converted into electric signals at the DVC CCD 222, and the converted signals are transmitted to the DVC signal processing block 112. The DVC CCD 222 preferably uses interlace scanning.

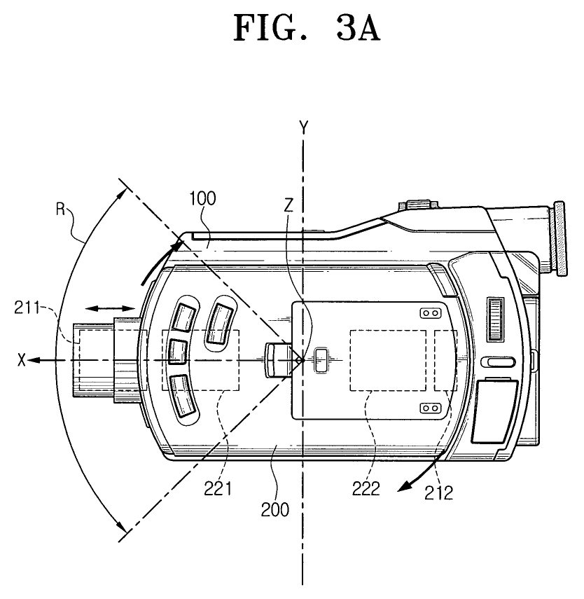

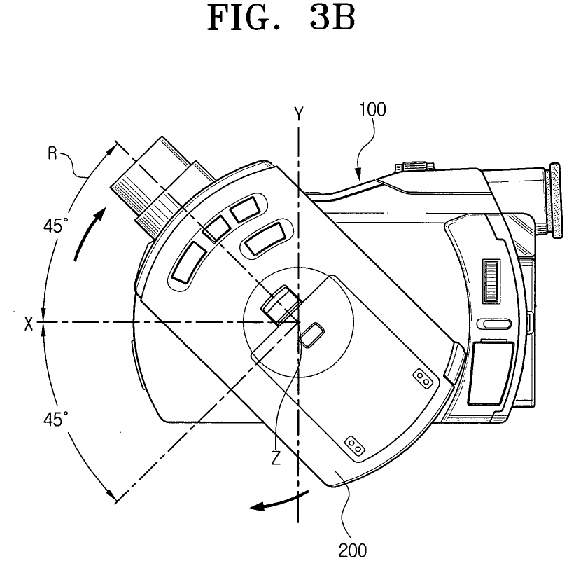

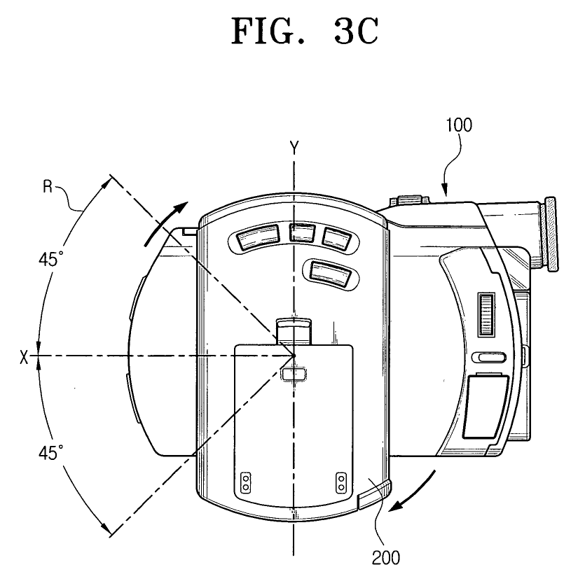

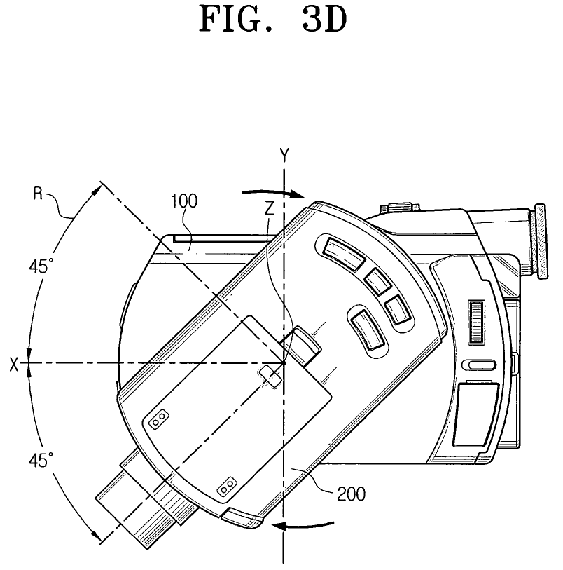

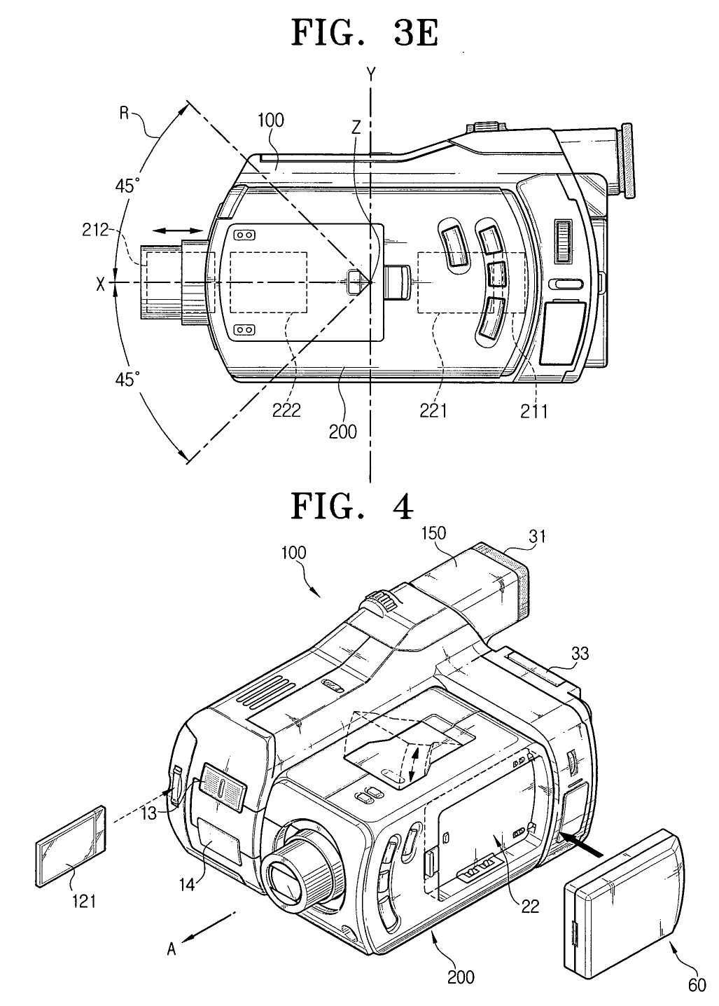

FIGS. 3A to 3E are views for the explanation of the complex camera unit 200. The complex camera unit 200 is mounted such that, according to the rotating manipulation by the user, the complex camera unit 200 turns about a Z axis to more than about 180° from the side views of the main body 100. According to the rotation angle of the complex camera unit 200 with respect to the main body 100, one of the DSC unit 201 and the DVC unit 202 of the complex camera unit 200 performs photographing. More specifically, whichever camera unit is positioned within the vertical angle of 45° with reference to the left side of the X axis performs the photographing.

FIGS. 3A to 3E show the position of the complex camera unit 200 according to the rotation of the complex camera unit 200 by 45° increments in the clockwise direction. Referring to FIG. 3A, the elements in the dotted lines respectively represent the DSC lens unit 211, the DSC CCD 221, the DVC lens unit 212 and the DVC CCD 222, which are installed inside the complex camera unit 200, and for the convenience in explanation, the DSC lens driving unit 231 and the DVC lens driving unit 232 are omitted from the drawing. Referring to FIGS. 3A and 3B, the DSC is in an operation mode in which the DSC unit 201 performs the photographing, because the DSC lens unit 211 and the DSC CCD 221 are positioned within the vertical angle R of 45° with reference to the left side of the X axis. Referring to FIG. 3C, there is no camera unit positioned within the vertical angle R of 45° with reference to the left side of the X axis. Accordingly, neither camera unit is positioned to perform the photographing.

Referring to FIGS. 3D and 3E, the DVC lens unit 212 and the DVC CCD 222 are positioned within the vertical angle R of 45° with reference to the left side of the X axis. Accordingly, the DVC unit 202, which is positioned within the vertical angle R of 45° with reference to the left side of the X axis, performs the photographing.

Referring to FIGS. 1 and 2, the main body 100 of the photographing apparatus may house respective components of the photographing apparatus, except the components of the complex camera unit 200 and the mode selection switch unit 300.

The DSC signal processing block 111 processes the signals from the DSC CCD 221 in frame units, and outputs digital still image data. According to the control of the DSC control unit 142, the DSC signal processing block 111 may modify color, color depth, color brightness and shutter speed during photographing. A JPEG compression unit 181 compresses the data received from the DSC signal processing block 111 to JPEG format. The JPEG format data is stored on a removable IC memory card 121.

The DVC signal processing block 112 processes the signals from the DVC CCD 222 in field units, and outputs the digital motion picture data. According to the control by the main control unit 141, the DVC signal processing block 112 can modify the color, color depth, color brightness and shutter speed. A MPEG compression unit 182 compresses the data received from the DVC signal processing block 112 to MPEG format data. The MPEG format data has a high compression ratio and therefore, is suitable for storage on a recording medium having a small memory capacity. However, the MPEG format data provides a lower quality image than the JPEG format. Accordingly, the MPEG format data is stored on the removable IC memory card 121 which has a relatively smaller memory capacity than the magnetic tape 122.

Meanwhile, a Digital Video (DV) compression unit 183 compresses the digital motion picture data from the DVC signal processing block 112 to DV format data. The DV format compression compresses data with the information in the frame only, and is capable of searching the digital image data which is recorded in the tape by helical scanning. Although it provides relatively good image quality, the DV format data has a low compression ratio, and therefore, should be stored on the recording medium with a high memory capacity. Accordingly, the DV format data is stored on the magnetic tape 122 which has a relatively higher memory capacity than the IC memory card 121.

Referring to FIG. 1, on one end of the main body 100, more specifically, towards the rear end of the main body 100 which is facing in the photographing direction ‘X’, there are a speaker 13 to output reproduced sound, and a microphone 132 to acquire external sound.

Referring to FIG. 2, the microphone 132 converts externally-input sound signals into electric signals. An ITU-T recommendation G.726 (G.726) compressing unit 184 compresses the signal from the microphone 132 to G.726 format data. The G.726 format data is stored on the IC memory card 121 together with the MPEG format data which is output from the MPEG compressing unit 182. Meanwhile, a pulse code modulation (PCM) compressing unit 185 compresses the signals from the microphone 132 to PCM format data, and the PCM format data is stored on the magnetic tape 122 via the VCR deck 124 together with the DV format data which is output from the DV compressing unit 183.

As for the recording medium, there is an IC memory card 121 and a magnetic tape 122. The IC memory card 121 can directly connect to the PC, which enables easy data transmission. However, having a relatively small memory capacity, the IC memory card 121 is usually used for the storage of small-volume of data. The IC memory card 121 is one type of recording medium, which is usually formed as a card. The IC memory card 121 has one or more semiconductor memories contained in the casing, and an interface connector provided at an end which is usually used to expand memory capacity. The IC memory card 121 can be categorized depending on the type of the memories contained therein, such as a RAM card, a flash memory card or a non-volatile semiconductor memory card. FIG. 4 is a view according to an embodiment of the present invention illustrating the method of mounting removable IC memory card in the body. Meanwhile, the magnetic tape 122 is inserted in the VCR deck 124 which is driven by the VCR deck driving unit 123, and has a larger memory capacity than the IC memory card 121.

A character generating unit 155 receives a control signal from the main control unit 141, and accordingly generates certain letters at corresponding positions on the display unit 150.

An IEEE-1394 interface unit 191 is used to exchange data with other external devices, and is usually used for interfacing with a PC. In other words, the digital image data can be transmitted to the PC via the IEEE-1394 interface unit 191, and the digital image data can also be recorded from the PC to the magnetic tape 122.

Referring back to FIG. 1, the display unit 150 includes a view finder 151 which is provided to the main body 100 to display image as captured, and a LCD panel 152 which is also provided to the main body 100.

Still images, captured by the DSC, are stored in the removable IC memory card 121, and the motion picture captured by the DVC is selectively stored in the IC memory card 121 or the magnetic tape 122. The storage path can be set by the user as he or she prefers. The user uses a recording medium selecting switch 131 provided to the key input unit 130 to select the recording medium for the motion picture storage. That is, the recording medium selecting switch 131 outputs a memory card recording mode signal or a tape recording mode signal to the main control unit 141 in accordance with the selection made by the user.

Meanwhile, the user may also select the recording medium through a recording medium setting unit (not shown). In this case, the recording medium setting unit includes the key input unit 130, the character generating unit 155 and the display unit 150. The key input unit 130 is provided with a menu display key for inputting a command to the display menu screen on the display unit, a direction key for moving a cursor with respect to the items selectively arranged on the menu screen, and a selection key for selecting the item where the cursor is placed. When the user presses the menu key, the key input unit 130 transmits a menu display signal to the main control unit 141. Likewise, if the user presses the direction key, the key input unit 130 transmits a cursor moving signal to the main control unit 141, and the key input unit 130 transmits an item selection signal when the selection key is pressed. The main control unit 141 in receipt of the menu display signal signals the character generating unit 155 to display a menu screen on the display unit 150. When receiving a cursor moving signal, the main control unit 141 signals the character generating unit 155 to indicate that the cursor has moved on the display unit 150. Meanwhile, the main control unit 141 in receipt of the item selection signal controls the character generating unit 155 to indicate a sub-menu of the item on the display unit, and in the absence of sub-menu, the main control unit 141 controls the operations corresponding to the menu items.

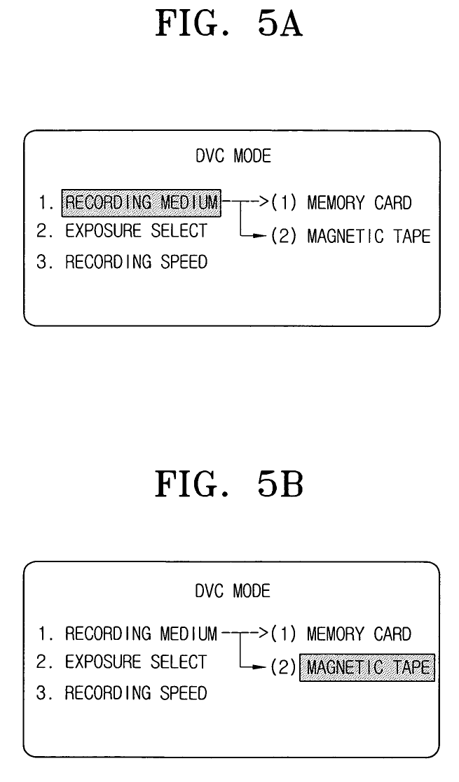

FIGS. 5A and 5B are views for illustrating the process of setting a recording medium, using a menu screen. As shown in FIG. 5A, when the user presses the menu display key while the photographing apparatus is operated in the DVC operation mode, the DVC menu screen is displayed on the display unit 150. As the user places the cursor on the item ‘1. recording medium’ and presses the selection key, the sub-menus of the ‘1. recording medium’ item, such as ‘(1) memory card’ and ‘(2) magnetic tape’, are displayed. As shown in FIG. 5B, as the user places the cursor on the sub-item ‘(2) magnetic tape’ and presses the selection key, the main control unit 141 sets a storage path along which the captured motion pictures are stored on the magnetic tape 122.

Referring again to FIG. 2, the main control unit 141 and the DSC control unit 142 constitute control unit 140. The main control unit 141 determines based on the operation mode signal received from the mode selection switch unit 300 whether the current operation mode is DSC operation mode or the DVC operation mode. The main control unit 141, while in the DSC operation mode, controls the DSC control unit 142, which controls the DSC lens driving unit 231 and the DSC signal processing block 111, respectively. Accordingly, the optical image captured through the DSC lens unit 211 is photoelectrically converted into electric signals at the DSC CCD 221, and the converted signals are converted into digital still image data at the DSC signal processing block 111. The converted data is compressed to JPEG format data at the JPEG compression unit 181. The main control unit 141 manipulates on the stored data selecting switch 173 so that the JPEG format data from the JPEG compression unit 181 can be stored on the preferably removable IC memory card 121.

Meanwhile, the main control unit 141, upon determining the DVC operation mode has been selected, controls the DVC lens driving unit 232 and the DVC signal processing block 112. The optical image captured through the DVC lens unit 212 can be photoelectrically converted to electric signals at the DVC CCD 222, and converted to digital motion picture data at the DVC signal processing block 112. Based on the recording mode signal received from the recording medium switch 131 or from the recording medium setting unit (not shown), the main control unit 141 determines whether the current recording mode is the IC memory recording mode or the tape recording mode. If the main control unit 141 determines the IC memory recording mode has been selected, the main control unit 141 manipulates the motion picture compression format selecting switch 171 and the sound compression format selecting switch 172 so that the digital motion picture data output from the DVC signal processing block 112 can be appropriately compressed. The digital motion picture data is compressed to MPEG format data, and the sound signal output from the microphone 132 is compressed to G.726 format data at the G.726 compression unit 184. By manipulating the stored data selecting switch 173, the main control unit 141 causes the MPEG format data and the G.726 format data to be stored on the IC memory card 121.

If the main control unit 141 determines the magnetic tape recording mode has been selected, the main control unit 141 manipulates the motion picture compression format selecting switch 171 and the sound compression format selecting switch 172 so that the digital motion picture data output from the DVC signal processing block 112 can be compressed. The digital motion picture data is compressed to DV format data at the DV compression unit 183, and the sound signal output from the microphone 132 can be compressed to the PCM format data at the PCM compression unit 185. The DV format data and the PCM format data is stored on the magnetic tape 122 via the VCR deck 124.

The mode selection switch unit 300 operates in association with the complex camera unit 200. The mode selection switch unit 300 outputs to the main control unit 141 an operation mode signal corresponding to the rotation angle of the complex camera unit 200, and the main control unit 141 determines the current operation mode with the received operation mode signal.

As shown in FIG. 3A, when the DSC lens unit 211 and the DSC CCD 221 are positioned within the vertical angle range of approximately 45° with respect to the X axis, the mode selection switch unit 300 outputs the DSC operation mode signal to the main control unit 141 and the control unit 140 operates the DSC unit 201, while keeping the DVC unit 202 off. Meanwhile, when the DVC lens unit 212 and the DVC CCD 222 are positioned within the vertical angle range of approximately 45° with respect to the X axis, the mode selection switch unit 300 outputs the DVC operation mode signal to the main control unit 141, and accordingly, the control unit 140 operates the DVC unit 202, while keeping the DSC unit 201 off.

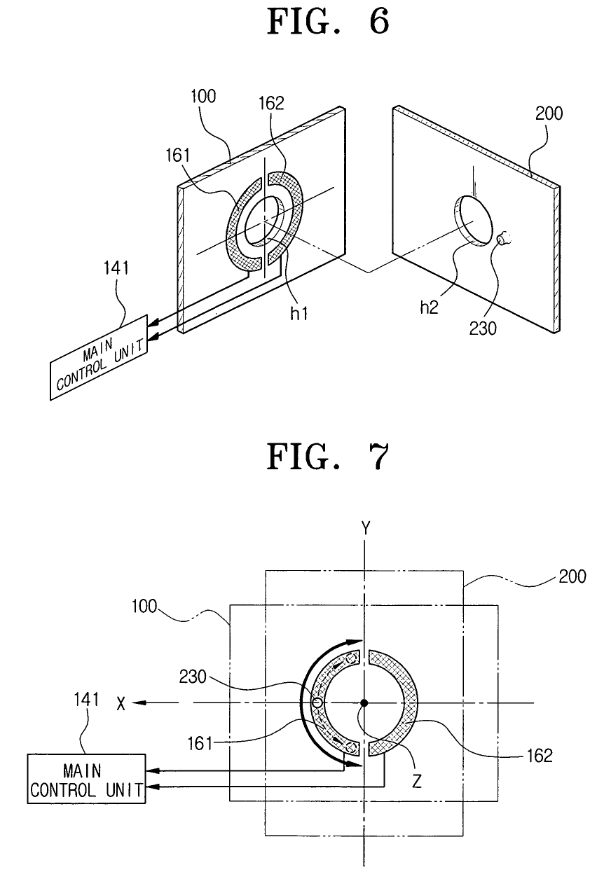

FIGS. 6 to 10 illustrate a mode selecting switch unit according to an embodiment of the present invention. FIG. 6 is a perspective view for explaining an exemplary mode selecting switch unit 300 of FIG. 2. Referring to FIG. 6, the switch may include first and second connection patterns 161, 162 provided on the main body 100, and a connection terminal 230 provided on the complex camera unit 200 to contact either one of the two connection patterns 161, 162. In the above-mentioned construction, the main body 100 and the complex camera unit 200 are connected, with facing holes h1 and h2, which rotate relative to each other. Accordingly, in accordance with the rotation angle of the complex camera unit 200 with respect to the main body 100, the connection terminal 230 contacts either the first connection pattern 161 or the second connection pattern 162. The first connection pattern 161 is connected to a first port of the main control unit 141, and the second connection pattern 162 is connected to a second port of the main control unit 141.

FIG. 7 is a view illustrating the state where the DSC unit 201 is selected by the exemplary switch of FIG. 6. In this case, as the connection terminal 230 contacts the first connection pattern 161 as shown in FIG. 7. When the rotation angle of the complex camera unit 200 is within a first angle range, and more specifically, within the vertical angle range of 90° with respect to the left side of the X axis, a binary signal ‘1’ of the DSC operation mode signal for operating the DSC unit 201 is output to the first port of the main control unit 141. A binary signal ‘0’ is output to the second port of the main control unit 141. As a result, the DSC operation mode in which the DSC unit 201 performs the photographing is selected, and the control unit 140 operates the DSC unit 201 while keeping the DVC unit 202 off.

When the connection terminal 230 contacts the second connection pattern 162 after rotating the complex camera unit 200. The connection terminal 230 is within the vertical angle range of 90° with respect to the right side of the X axis. At this position, a binary signal ‘1’ of DVC operation mode signal is output to the second port of the main control unit 141, and a binary signal ‘0’ is output to the first port of the main control unit 141.

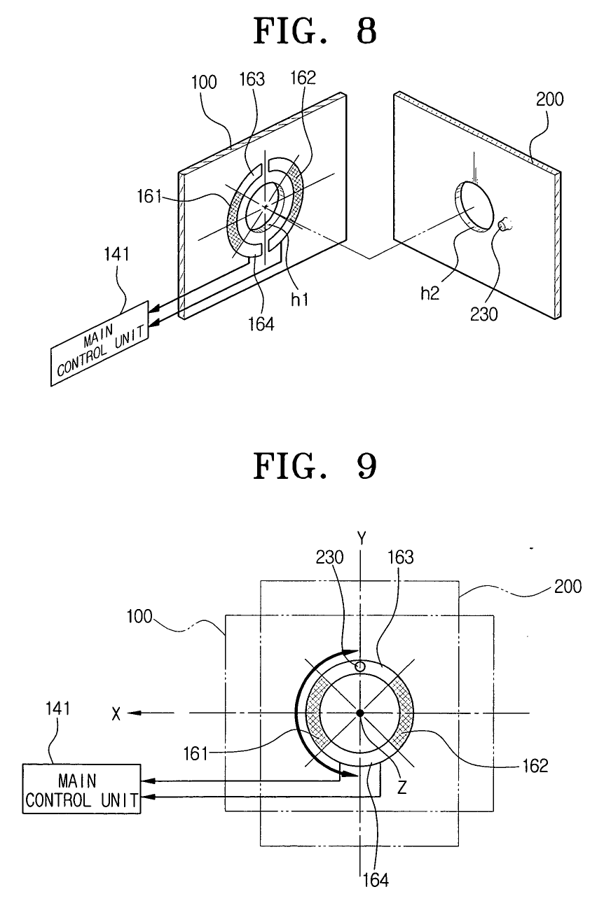

FIG. 8 is a perspective view for the explanation of another exemplary mode selection switch unit 300 of FIG. 2. The exemplary switch as shown in FIG. 8 further includes third 163 and fourth 164 connection patterns in addition to the first 161 and second 162 connection patterns of the main body 100, and may be constructed to include the connection terminal 230 which is provided on the complex camera unit 200 to contact one of the connection patterns 161 through 164. According to the rotation angle of the complex camera unit 200 with respect to the main body 100, the connection terminal 230 contacts one of the first 161 through fourth 164 connection patterns. The first connection pattern 161 is connected to the first port of the main control unit 141, the second connection pattern 162 to the second port, and the third 163 and the fourth 164 connection patterns are not connected to the ports of the main control unit 141.

FIG. 9 is a view illustrating the state where no camera unit is selected by the exemplary switch of FIG. 8. As shown in FIG. 9, as the connection terminal 230 contacts the third connection pattern 163, when the rotation angle of the complex camera unit 200 falls within a third range. This third range is contacted when the connection terminal 230 is within the horizontal angle range of 45° with respect to an upper side of Y axis. In this position, no operation mode signal is output to the ports of the main control unit 141. The same situation applies to the case where the connection terminal 230 contacts the fourth connection pattern 164. Accordingly, in the absence of operation mode signal, the control unit 140 turns of the camera unit, and therefore, neither the DSC unit 201, nor the DVC unit 202 is operated.

Here, it is assumed that the first 161 through the fourth 164 connection patterns are arranged at 90° intervals. In this case, when the connection terminal 230 is positioned within the vertical angle range of 45° with respect to the left side of the X axis, the DSC unit 201 is operated. When the connection terminal 230 is positioned within the vertical angle range of 45° with respect to the right side of the X axis, the DVC unit 202 is operated. No camera unit is operated if the connection terminal 230 is positioned within the horizontal angle range of 45° with respect to the upper or lower side of Y axis. As described above, both of the camera units are in an off state within the horizontal angle range of 45° with respect to the Y axis. This is to prevent the undesirable collision of the DSC 211 or the DVC 212 lens units with the main body 100 in the case that the user selects a zoom function and rotates the complex camera unit 200 with the DSC 211 and DVC 212 lens units, extending outside.

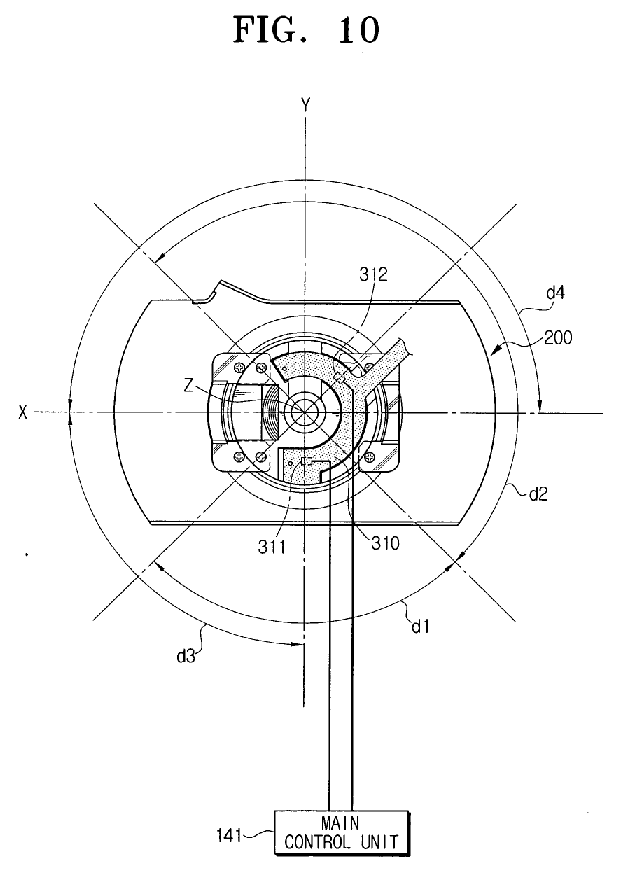

FIG. 10 is a view for the explanation of another example of the mode selection switch unit 300 of FIG. 2. Referring to FIG. 10, a mode switch unit 310 is provided to a contact surface between the complex camera unit 200 and the main body 100, and there are a DSC mode switch 311 and a DVC mode switch 312 provided to the mode switch unit 310. The DSC mode switch 311 is connected to the first port of the main control unit 141, and the DVC mode switch 312 is connected to the second port of the main control unit 141. As the complex camera unit 200 is rotated with respect to the main body 100, the mode switch unit 310, the DSC mode switch 311 and the DVC mode switch 312 are also rotated altogether.

The DSC mode switch 311 rotates and switches within the ranges d1 and d2. When the DSC mode switch 311 is positioned within the range d1, that is, within the horizontal angle range of 45° to the right side of the lower Y axis, a binary signal ‘1’ of DSC operation mode signal to operate the DSC unit 201 is output to the first port of the main control unit 141. A binary signal ‘0’ is output to the second port of the main control unit 141. Meanwhile, the DVC mode switch 312 rotates and switches within the ranges d3 and d4. When the DVC mode switch 312 is positioned within the range d3, that is, within the horizontal angle range of 90° with respect to the lower side of Y axis, a binary signal ‘1’ of DVC operation mode signal to operate the DVC unit 202 is output to the second port of the main control unit 141, and a binary signal ‘0’ is output to the first port of the main control unit 141.

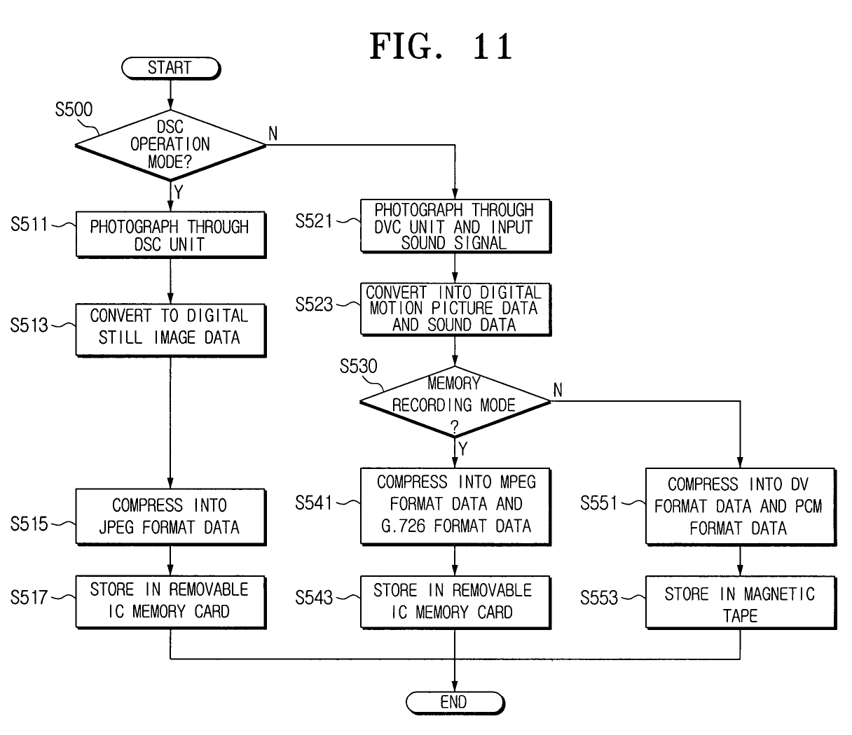

FIG. 11 is a flowchart illustrating the photographing method according to an embodiment of the present invention. Referring to FIG. 11, the main control unit 141 determines the operation mode based on the operation mode signal received from the mode selection switch unit 300 (S500).

When it is determined that the DSC operation mode has been selected in S500, the DSC CCD 221 photoelectrically converts the optical image converged through the DSC lens unit 211 into electric signals. The electrical signals are transmitted to the DSC signal processing block 111 (S511). The DSC signal processing block 111 converts the signals to digital still image data (S513). The JPEG compression unit 181 compresses the digital still image data into JPEG format data (S515). The JPEG format data is stored in the removable IC memory card 121 (S517).

Meanwhile, when the DVC operation mode has been indicated in S500, the DVC CCD 222 photoelectrically converts the optical image converged through the DVC lens unit 212 and sound received by the microphone 132 into electric signals. The electrical signals are transmitted to the DVC signal processing block 112 (S521). The DVC signal processing block 112 converts the received signals into digital motion picture and sound data (S523). Based on the recording mode signal received from the recording medium selecting switch 131 or the recording medium setting unit, the main control unit 141 determines the recording mode (S530). When it is determined to be in IC memory recording mode in S530, the digital motion picture data output from the DVC signal processing block 112 is compressed to MPEG format data at the MPEG compression unit 182. The sound data is compressed to G.726 format data at the G.726 compression unit 184 (S541). The MPEG format data and the G.726 format data are stored on the IC memory card 121 (S543). Alternatively, when it is determined to be the tape recording mode in S530, the digital motion picture data output from the DVC signal processing block 112 is compressed to DV format data at the DV compression unit 183, and the sound data is compressed to PCM format data at the PCM compression unit 185 (S551). The DV format data and the PCM format data are stored on the magnetic tape via the VCR deck 124 (S553).

As described above, according to the present invention, when storing the images taken with a photographing apparatus having a plurality of different cameras and different recording media, the compression format is automatically selected depending on the user's selection of a recording medium. That is, when the user wants to store the image on the recording medium with a large storage capacity, a compression format with a low compression ratio is automatically selected to thereby provide a high quality image. Alternatively, when the user wants to store the image on the recording medium with a small storage capacity, a compression format with a higher compression ratio can be automatically set so that more motion picture data can be stored on the recording medium. Further, various compression methods can be automatically set, depending on the type of images captured by the respective cameras. As a result, the storage capacity of the recording medium can be used more efficiently, and the user is not inconvenienced by having to set the compression format for the respective camera and the recording medium every time he or she chooses the camera or the recording medium.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. The photographing apparatus comprising:
a digital video camera unit for generating digital motion picture data;
a first compression unit to compress the digital motion picture data into data compressed using a first compression format;
a second compression unit to compress the digital motion picture data into data compressed using a second compression format having a lower compression ratio than said first compression format;
a first and a second recording media to store first and second compressed data;
a recording medium selecting switch to select one of the first or the second recording media; and
a control unit to control the transmission of the digital motion picture data to one of the first or the second compression units based on the recording media selected by the recording medium selecting switch.

2. An apparatus of claim 1, wherein said first recording media is an integrated chip memory.

3. An apparatus of claim 2, wherein said first recording media is removable from the apparatus.

4. An apparatus of claim 1, wherein said first recording medium stores data compressed by said first compression unit.

5. An apparatus of claim 1, further comprising a third and a fourth compression units to compress sound data captured by a microphone.

6. An apparatus of claim 5, wherein either said third or fourth compression unit is selected based upon the recording medium selected by said recording medium selecting switch.

7. An apparatus of claim 6, wherein said first recording medium stores data compressed by said third compression unit, which uses a compression format different from said fourth compression unit.

8. An apparatus of claim 6, wherein said second recording medium stores data compressed by said fourth compression unit, which uses a compression format different from said third compression unit.

9. A method for selecting the compression format for a photographed image comprising the steps of:
selecting the medium on which to record the photographed image from a plurality of recording media;
storing compressed image data that was compressed using a first compression method if a first recording medium is selected in the selecting step; and
storing compressed image data that was compressed using a second compression method if a second recording medium is selected in the selecting step.

10. A method of claim 9, wherein said first recording medium is an integrated chip memory.

11. A method of claim 9, wherein a first of said plurality of recording media is removable from said photographing apparatus.

12. A method of claim 9, wherein a second of said plurality of recording media is a magnetic tape.

13. A method of claim 9, wherein using said first compression method results in compressed image data being compressed at a higher compression ratio than image data compressed using the second compression method.
